(19) United States
(12) Patent Application Publication
(10) Pub. No.: US 2011/0024452 A1
(43) Pub. Date: Feb. 3, 2011

(54) CONTAINER ASSOCIABLE WITH AIRLESS PUMPS AND METHOD FOR ITS PRODUCTION

(75) Inventor: Matteo MORETTI, Crema (IT)

Correspondence Address: OBLON, SPIVAK, MCCLELLAND MAIER & NEUSTADT, L.L.P., 1940 DUKE STREET, ALEXANDRIA, VA, 22314, US

(73) Assignee: LUMSON S.p.A, Capergnanica (IT)

(21) Appl. No.: 12/844,400

(22) Filed: Jul. 27, 2010

(30) Foreign Application Priority Data
Jul. 31, 2009 (IT) MI2009A 001397

(51) Int. Cl. B65D 35/56; B67D 7/60

(52) U.S. Cl. 222/105; 222/386.5

(57) ABSTRACT

A refill for devices for dispensing fluid substances contained in a deformable bag, comprising a substantially rigid protection element (5) having an aperture providing access to the body cavity, and a bag (9) positioned in the interior of the protection element (5), the bag presenting a neck (2) for access to the cavity of the bag (9) and for sealedly housing the body of a hermetic pump (P), said protection element presenting at least one air passage enabling air to enter its interior.

The present invention relates to a device for dispensing fluid substances contained in a deformable bag, and a refill for said device.

It is known to enclose fluid substances (both liquid and creamy) in containers from which these substances are dispensed by manually operating a small pump mounted on the mouth of a respective container. Pump operation causes a quantity of fluid substance to be withdrawn from the container in which—if the container is rigid—a vacuum forms which would prevent further substance withdrawal and dispensing, if air were not allowed to enter the container (which generally takes place in those regions in which the pump makes contact with and slides on the pump body), or if the container did not comprise a base sealedly movable along an internal cylindrical surface of the container (see for example U.S. Pat. No. 4,691,847, U.S. Pat. No. 4,694,977 and U.S. Pat. No. 5,971,224): this latter system for compensating the container volume by reducing its internal volume while maintaining the internal pressure constant is however very laborious and costly.

In many cases it is opportune or necessary that the fluid substance to be dispensed by a pump never comes into contact with the atmosphere inside the container (with the dispensing pump mounted on it): sealing the fluid out of contact with the atmosphere is important if the composition of the fluid within the container is not to undergo alteration, or if it is essential that the fluid substance enclosed in the container remains sterile. To achieve this, U.S. Pat. No. 3,420,413 has proposed a device comprising a bag containing the fluid substance which is to remain isolated (from the atmosphere) inside the bag which (see column 4, lines 22-28) is made of elastically deformable flexible material and has a neck on which a support element (having a profiled aperture for housing a pump) is sealedly applied after the bag has been filled with the fluid substance to be dispensed: after this, a pump is sealedly mounted on said support element to hence prevent contamination of the fluid substance by the air (column 5, lines 15-38). The bag containing the fluid substance and having the pump sealedly mounted on its neck is then inserted into a rigid body (obviously being very careful that the free end of the rigid body does not come into contact with the bag filled with fluid substance, in order not to break it) on which said support element is then positioned and fixed (column 5, lines 56-61). Hence between the outer surface of the bag and the inner surface of the rigid body an interspace is formed which is connected to atmosphere via a hole provided in the container base; in this manner, when the fluid substance is withdrawn from the bag by operating the pump, the bag is squeezed by the atmospheric pressure so that the substance can be easily withdrawn and expelled to the outside by the pump (column 5, lines 70-73). The main drawback of the aforesaid device is that the deformable bag must be filled with fluid substance before the bag is inserted into the respective rigid container, and that the operation involved in inserting the bag into the container is very delicate because the bag can be easily torn while being inserted into the container interior.

As can be easily deduced from the aforegoing, the bag already filled with dispensable fluid is very delicate in that it evidently has to be easily deformable to enable the entire product to be properly dispensed. Consequently it cannot be easily transported and stocked, for example on the shelves of supermarkets where it is available to the customer, as its wall is very thin.

The main object of the present invention is therefore to provide a device of the stated type which is able to be recharged with bags filled with dispensable fluid which bags can be easily stocked, transported and replaced in the device when the bag is empty.

These and other objects are attained by a device in accordance with the technical teachings of the accompanying claims.

The ensuing description provides non-limiting embodiments of the invention, which is indicated by way of non-limiting example; it is represented with the aid of the accompanying drawings, in which:

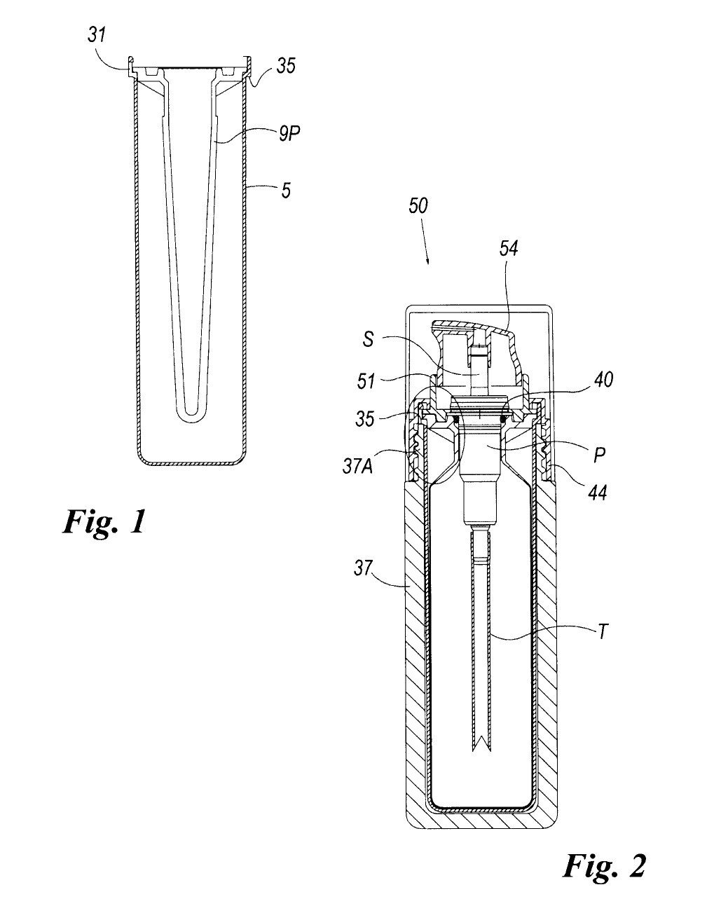

FIG. 1 is a section through a preform from which a bag is formed by blow moulding; the preform is inserted into a protection element;

FIG. 1A is a section through a refill obtained by inflating the preform of FIG. 1;

FIG. 2 is a dispensing device into which the refill of FIG. 1A is inserted;

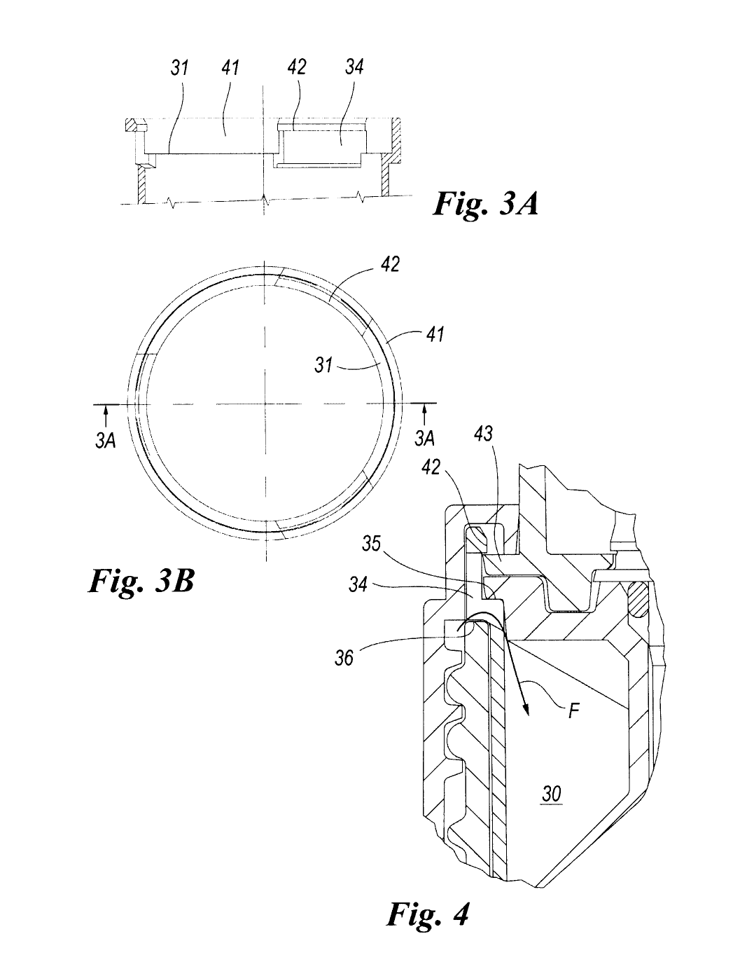

FIG. 3A is an enlarged partial section through the protection element taken on the line 3A-3A of FIG. 3B;

FIG. 3B is a top view of the object represented in FIG. 1;

FIG. 4 is an enlargement of the area enclosed within the ellipse of FIG. 2;

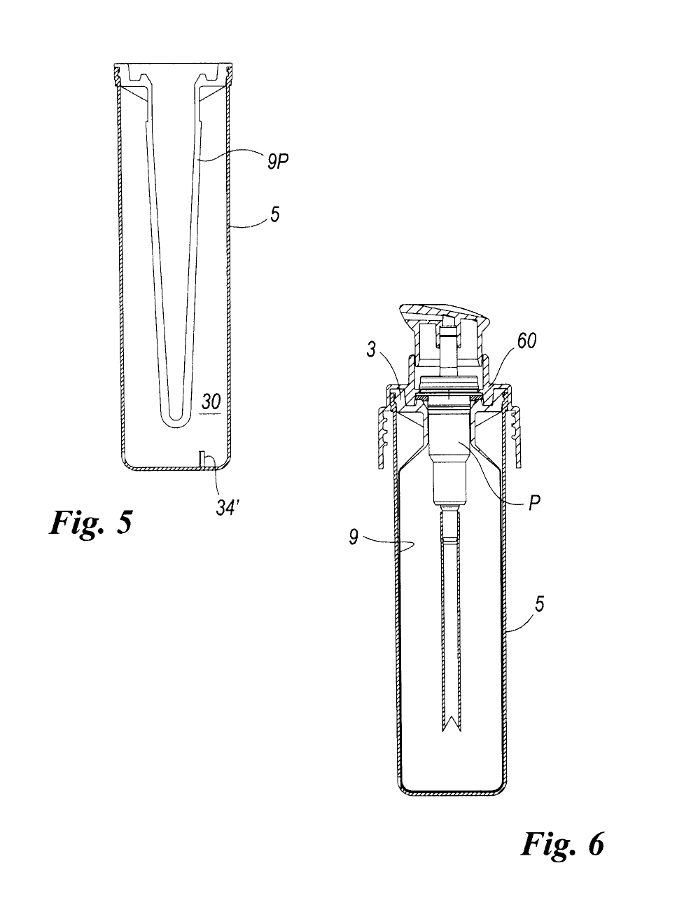

FIG. 5 shows a different embodiment of the preform and protection element of FIG. 1;

FIG. 5A is a section through a refill formed by inflating the preform of FIG. 1A;

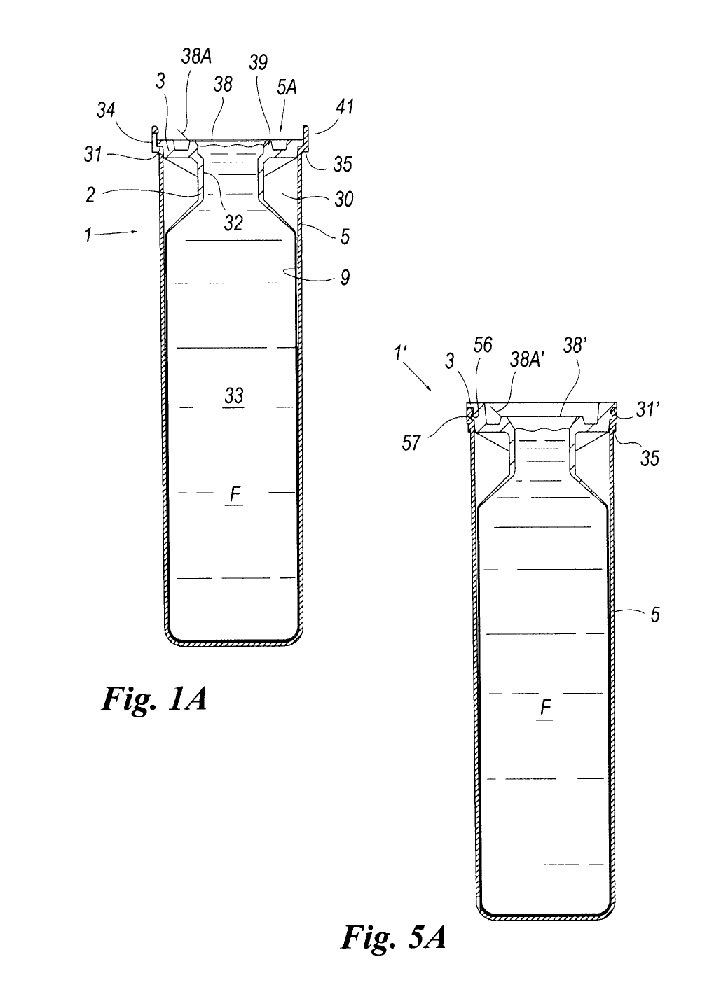

FIG. 6 shows a different embodiment of the refill of the present invention;

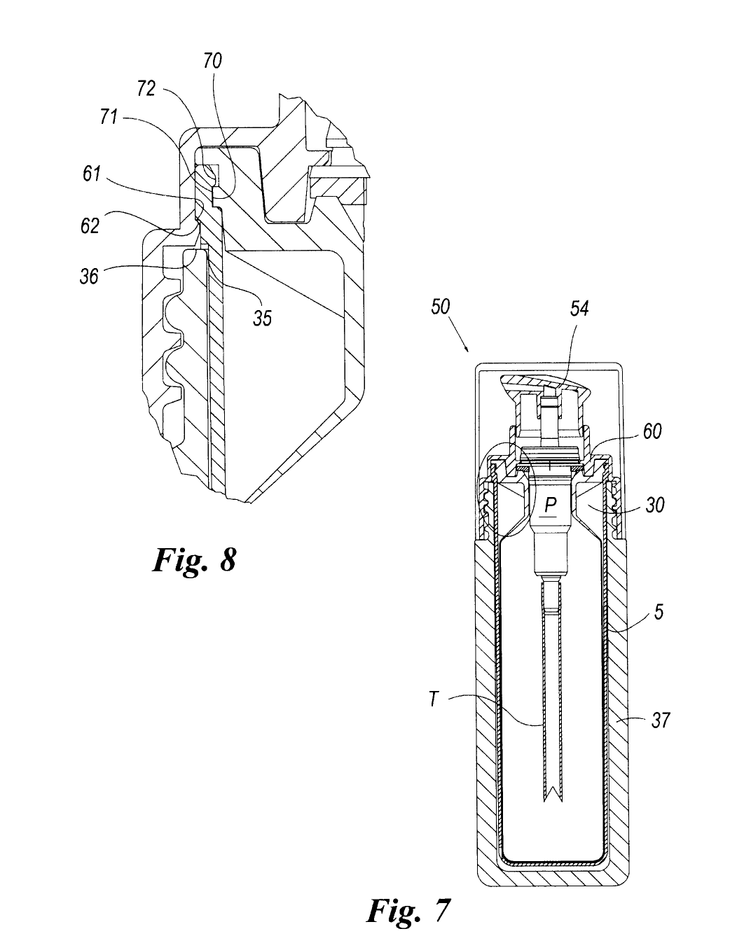

FIG. 7 shows a complete dispensing device into which the unit of FIG. 6 has been inserted;

FIG. 8 is an enlargement of the area enclosed within the ellipse of FIG. 2;

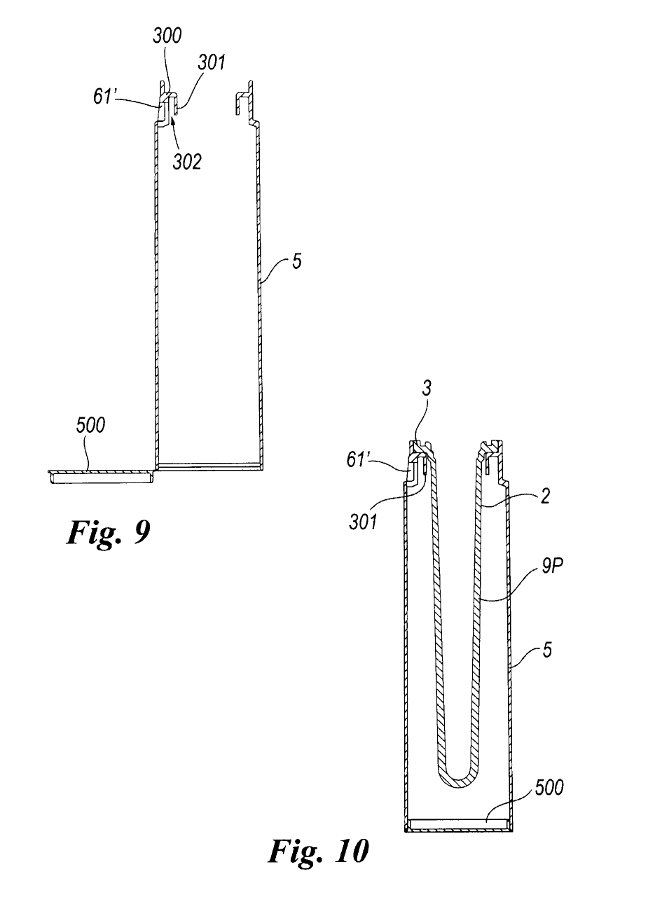

FIG. 9 shows an alternative embodiment of the protection element of the present invention;

FIG. 10 shows the element of FIG. 9 into which the preform of a deformable bag is inserted;

FIG. 11 shows the configuration of FIG. 10 after the preform has been hot-inflated;

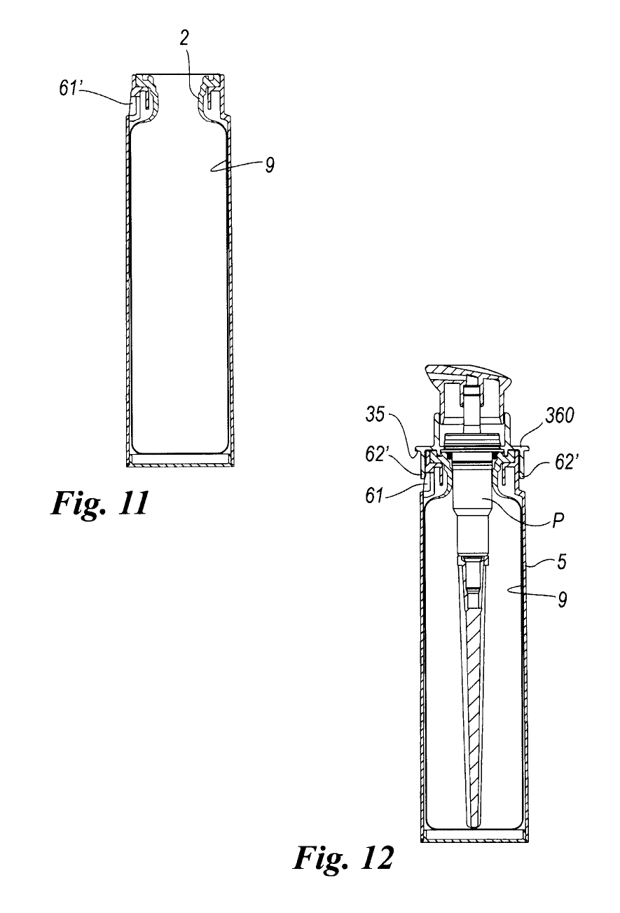

FIG. 12 shows the refill of FIG. 11 coupled to a pump; and

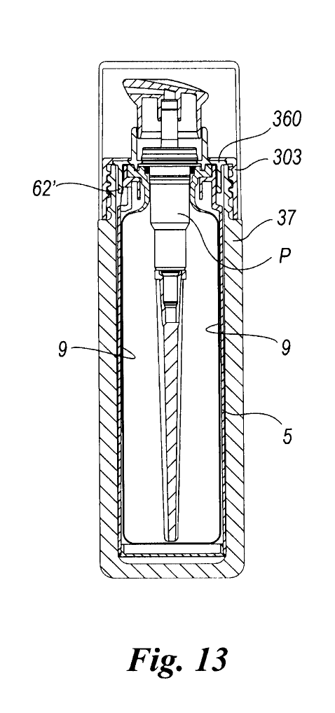

FIG. 13 shows the dispensing device complete with the refill of FIG. 11.

Reference will firstly be made to FIG. 1 which shows a preform 3 inserted into a protection element 4.

When the preform has been heated and inflated by known methods, the structural configuration of the refill 1 of FIG. 1A is obtained.

The refill comprises a substantially rigid protection element 5 having an aperture 5A providing access to the body cavity 30, and a bag 9 positioned in the protection element 5. The bag 9 is made of thermoplastic material, such as deformable PE. It presents a neck 2 from which a flange 3 extends radially to rest on a edge 31 of the aperture 5A of the element 5. The neck bounds a hole 32 for access to the cavity 33 of the bag 9 and for housing sealedly (for example by means of a gasket 40) the body of a hermetic pump P operable manually to withdraw the fluid substance F from the bag and to feed it to the outside through its dispensing stem S.

The bag 9 is made by hot blow moulding a preform 9P positioned directly inside the protection element 5.

The bag 9 can also be made by different method, for example by known method of extrusion or by film welding. Both methods can use aluminium or multilayer thermoplastic material with one or more layers of aluminium. The thermoplastic material can be PP—PE or PA. In this solution the neck and the flange will have a different configuration because it will be larger than what represented in FIG. 1. Anyway it is important that a perfect sealing between the neck and the body of the pump is be obtained. This can be achieved by a different configuration of the body of the pump, that can have a larger body of a diameter similar to the diameter of the neck, or by an intermediated ring member sealedly fixed both to the pump and to the bag.

At its edge 31, the protection element 5 presents a passage 34 connecting the external environment to the cavity 30 defined by the element 5.

According to the present invention the protection element comprises an abutment 35 arranged to abut against a stop 36 provided in an external container 37 when the refill device 1 is inserted into it, to maintain the refill device 1 in position.

FIG. 1A shows the refill 1 filled with fluid F, the fluid being sealed within the bag 9 by a closure element 38 provided on the aperture of the neck 2. Advantageously the closure element is a film, for example of multi-layer type with some layers being of polymer and others of aluminium, bonded to a projecting edge 39 of the neck. It presents a tab 38A enabling it to be easily removed.

In a variant the closure element is also associated with the protection element 5, such as to close the top of the refill.

In a further embodiment it can for example be made of a perforable material which tears when the pump P is inserted into the neck 2 of the bag 9.

In the aforedescribed embodiment the abutment present in proximity to the aperture 5A is a step 31 formed in the wall of the protection element 5. From the step 31 an annular wall 41 projects on which teeth 42 are provided.

When mounting the refill in the dispensing device 50 (FIG. 2), the teeth are arranged to cooperate with a flange 43 associated (directly or via an intermediate element 51 to which the flange pertains) with the pump P to lock it to the bag 8 by snap action (see the enlargement of FIG. 4). The pump is associated with the bag and then locked (preferably snap-wise) in the protection element 5. Once the pump is associated with the bag, the refill is positioned in the external container 37. The abutment 35 rests against the free edge of the mouth 37A of the external element, such as to remain stable within the external element 37.

A ring nut 44 is then mounted on the pump P and screwed down on a thread present on the external element, then a dispensing cap 54 is fitted onto the pump stem. The ring nut presses on the pump via the intermediate element 51, to sandwich-compress the bag 9 between the intermediate element 51 and the external element 37.

It should be noted that said passages 34 are provided precisely below the teeth 42. When the refill 1 is inserted into the dispensing device (FIG. 4), the passages 34 enable air to flow from the outside to the cavity 30 (see arrow F in FIG. 4), so that the bag can freely deform gradually as the fluid in its interior is dispensed by the stem S of the pump P associated with a dip tube T.

In an alternative embodiment, the intermediate element 51 can be made integral with the ring nut 44.

A different embodiment of the refill 1 is shown in FIG. 5A. The refill 1′ shown here derives from blow-moulding the preform 9P of FIG. 5, filling (FIG. 5A) with fluid, then closing with a closure element totally similar to that already described.

In this embodiment the same reference numerals are used to indicate parts similar to those already described previously.

The differences between the previously described embodiment and that of FIG. 5A lie specifically in the method of coupling the bag to the protection element. In this case the flange 3 is rested on the free edge 31′ of the protection element 5 and presents a tooth 56 which snap-engages in an undercut 57 provided in the inner surface of the protection element 5. The dispensing device provided with the refill 1′ is only slightly different from that already described. It is shown overall in FIG. 7. In this case the ring nut and the intermediate element described previously are formed as a single fixing element 60. The fixing element comprises means for its snap-association with the combined bag/protection element. Specifically the snap-association means act between the fixing element 60 and the protection element 5 and, for example (FIG. 8), comprise an annular tooth 62 which engages a tooth 61 formed on the outer surface of the protection element. It should be noted that again in this case the protection element comprises at least one air passage 34′ (well visible in FIG. 5) which connects its cavity 30 to the outside.

The use of the refill of FIG. 5A is totally similar to that described for the refill of FIG. 1A.

In some alternative embodiments, the aforedescribed refills can directly use the pump P as their closure element, instead of the film 38, 38A. In this case the pump is provided as an integral part of the refill.

In particular, in the case of the refill of FIG. 1A, the film can be replaced by the combined pump P/intermediate element 51. The intermediate element 51 locks the pump onto the bag by snap-engaging with the tooth or teeth 42 of the protection element.

In this lastly described case the final user, to recharge the dispensing device, simply has to unscrew the ring nut 44, remove it from the unit comprising the pump/intermediate element/bag/protection element, and replace this entire unit with a new refill as aforedescribed, and tighten the ring nut.

In the aforedescribed case it is evidently possible to provide an intermediate element formed integral with the ring nut. In this case the ring nut 44 is also replaced together with the refill.

That just stated with regard to the refill of FIG. 1A is also valid for the refill of FIG. 5A. Here the film 38A can be replaced by the pump P locked by the fixing element 60 to the protection element 5 which snap-engages this latter. At this point the refill is formed by the combination of FIG. 6.

In all the aforedescribed embodiments in which the bag is sealed by the pump, the refill may or may not comprise the dispensing cap.

It should be noted that the preform can be produced by moulding a plastic material, such as PE, PET, PP or the like, but also by co-moulding various layers of different materials together by injection moulding. It is heated to a temperature sufficient to soften (plasticize) the plastic material forming the preform. In the present method it is heated for example to a temperature of 120° C. for a time between 4 and 7 seconds.

Once heated, it is inserted into the body 5 to hence obtain a situation such as that of FIG. 1.

At least one air jet is then fed into the preform to inflate the preform in order to form the bag 9.

The protection element is shown here as a solid piece, however it can comprise a grid surface or lightening holes or ribs.

FIGS. from 9 to 13 show a different embodiment of the invention. To describe these figures the reference numerals used will be those already used to indicate similar parts.

In this embodiment the protection element 5 has a closable base formed by moulding together with the cylindrical walls of the protection element. Inside the protection element in proximity to its access mouth, a flange 300 is provided having a projection which extends towards the container base such as to form an annular groove 302 well visible in FIG. 9. The annular groove, and in particular the wall which defines it, enables the inflation of the bag 9P to be guided to hence facilitate formation of the neck 2, which connects the bag body to the flange 3.

Essentially, the preform 9P is placed in the container 5 and the base 500 of the protection element is closed. The previously heated preform is then inflated to form the bag (see FIG. 11). When duly filled, the bag forms the refill.

In the aforedescribed embodiment, it can be seen that a different method is used for fixing the refill to the pump.

An intermediate element 360 different from those previously described is provided, to which the refill is fixed and which locks the pump against the bag.

Specifically, the intermediate element 360 comprises means for snap-fitting to the combined bag/protection element (refill). The snap-fitting means act between the intermediate element 360 and the protection element 5, and comprise an annular coupling (or groove) 62′ which engages a tooth 61′ formed on the outer surface of the protection element (specifically below the flange 300). It should be noted that in this case three teeth 61′ are provided below the flange 300.

Hence the abutment 35 which is arranged to rest against the external container 37 is not directly formed on the protection element but is formed on the intermediate element 360 which is locked to the protection element by the described fitting means.

To complete the description, a ring nut 303 is present which sandwich-clamps the intermediate element 360 to the external container 37 (see FIG. 13).

Various embodiments of the invention have been described, however others can be conceived utilizing the same inventive concept.

In an alternative embodiment of the present invention the

1. A refill for devices for dispensing fluid substances contained in a deformable bag, comprising a substantially rigid protection element (5) having an aperture providing access to the body cavity, and a bag (9) positioned in the interior of the protection element (5), the bag presenting a neck (2) from which a flange (3) extends radially to rest on an edge of the aperture of the element (5), the neck (2) bounding a hole for access to the cavity of the bag (9) and for sealedly housing the body of a hermetic pump (P) operable manually to withdraw the fluid substance (F) from the bag and to feed it to the outside via a dispensing stem (S) thereof, said protection element presenting at least one air passage enabling air to enter its interior, the protection element comprising, rigid therewith, at least one abutment (35) arranged to abut against a stop (36) provided in an external container (37) of a dispensing device (50) when the refill device is within it, characterised in that the flange (3), the neck (2) and the bag (9) are formed in a single piece.

2. A refill as claimed in claim 1, characterised in that the protection element (5) comprises fixing means (42, 62) by which said pump is secured to the bag.

3. A refill as claimed in the preceding claim, wherein said fixing means (42, 62) are snap-acting means.

4. A refill as claimed in one or more of the preceding claims, wherein said protection element secures said pump via an intermediate element (43).

5. A refill as claimed in one or more of the preceding claims, wherein said protection element secures said pump by means of a fixing element (60) formed integrally with a ring nut for its connection to the external container.

6. A refill as claimed in one or more of the preceding claims, wherein said bag (9) comprises means (70, 71) for its snap-connection to said protection element (5).

7. A refill as claimed in one or more of the preceding claims, wherein the bag (9) is filled with a product to be dispensed, the hole (32) for access to the bag cavity being closed by a closure element (38, 38′, P).

8. A refill as claimed in one or more of the preceding claims, wherein said closure element (38, 38′) is also associated with said protection element.

9. A refill as claimed in one or more of the preceding claims, wherein said closure element (38, 38′) is made of perforable material.

10. A refill as claimed in one or more of the preceding claims, wherein said closure element (38, 38′) is a film bonded to a projecting edge (39) of said hole.

11. A refill as claimed in one or more of the preceding claims, wherein said closure element is said pump (P).

12. A refill as claimed in one or more of the preceding claims, wherein a ring nut (44, 60) is provided for fixing the dispensing device to an external container (37).

13. A refill as claimed in one or more of the preceding claims, wherein said protection element is made of rigid PP and/or rigid PE.

14. A refill as claimed in one or more of the preceding claims, wherein said bag is made of PE and/or PP and/or PET or their mixtures, all deformable, and or by a single or multilayer thermoplastic material preferably comprising a layer of aluminium.

15. A device for dispensing fluid substances contained in a deformable bag, comprising an external container (5) having a neck bounding an aperture for access to the body cavity, and a bag (9) positioned in the interior of the body (9), the bag being made of thermoplastic material and having a neck bounding a hole for access to the cavity of the bag (9), there being sealedly housed in the hole the body of a hermetic pump (P) operable manually to withdraw the fluid substance (F) from the bag and to feed it to the outside via a dispensing stem (S) thereof, characterised in that said bag (9) is contained in a protection element (5) in accordance with one or more of the preceding claims, the protection element protecting the bag during transport.

16. A device as claimed in the preceding claim, wherein the refill is sandwich-clamped between the closure ring nut and the external container (37).

17. A device as claimed in one or more of the preceding claims, wherein said refill is fixed by snap-action to a fixing element (60, 360) coupled to the external container (37).
